(19) United States
(12) Patent Application Publication
(10) Pub. No.: US 2019/0390129 A1
(43) Pub. Date: Dec. 26, 2019

(54) PRODUCTION OF IMPROVED BASE STOCKS

(71) Applicant: ExxonMobil Research and Engineering Company, Annandale, NJ (US)

(72) Inventors: Benjamin A. McCool, Annandale, NJ (US); Jason T. Calla, Raritan, NJ (US); Dhaval A. Bhandari, Bridgewater, NJ (US); Yogesh V. Joshi, Bridgewater, NJ (US)

(21) Appl. No.: 16/448,195

(22) Filed: Jun. 21, 2019

Related U.S. Application Data
(60) Provisional application No. 62/690,055, filed on Jun. 26, 2018.

(51) Int. Cl. C10M 101/02; B01D 61/36; B01D 67/00; C10G 31/09

(52) U.S. Cl. CPC C10M 101/02; B01D 61/364; B01D 67/0023; C10G 31/09; C10N 2220/022; C10G 2400/10; C10N 2230/06; C10N 2230/43; B01D 2257/702; B01D 2256/24; C10N 2220/021

(57) ABSTRACT

Methods and apparatuses are provided for producing base stocks by using a separation process that includes: conducting a hydrocarbon feedstream to a membrane separation zone wherein the feedstream contacts a first side of at least one membrane element; retrieving at least one retentate product stream from the first side of the membrane element; retrieving at least one permeate product stream from a second side of the membrane element; and converting at least a portion of the permeate product stream into the base stock. Also provided are base stocks produced by the separation process.

### CROSS REFERENCE TO RELATED APPLICATIONS

This application claims the benefit of U.S. Provisional Application No. 62/690,055, filed on Jun. 26, 2018, the entire contents of which are incorporated herein by reference.

### FIELD

The present application relates to methods and apparatuses for producing improved base stocks utilizing membrane separations.

### BACKGROUND

Base oil is the major constituent in finished lubricants and contributes significantly to the properties of the finished lubricants. For example, engine oils are finished crankcase lubricants intended for use in automobile engines and diesel engines and contain two general components, namely, a base stock or base oil (one base stock or a blend of base stocks) and additives. In general, a few lubricating base oils are used to manufacture a variety of engine oils by varying the mixtures of individual lubricating base oils and individual additives.

Governing organizations (e.g., the American Petroleum Institute) help to define the specifications for finished lubricants such as engine oils. Currently, formulators are using a range of base stocks spanning the range including Group I, II, III, IV, and V to formulate their products. Group I base stocks or base oils are defined as base stocks with less than 90 wt % saturated molecules and/or at least 0.03 wt % sulfur content. Group I base stocks also have a viscosity index (VI) of at least 80 but less than 120. Group II base stocks or base oils contain at least 90 wt % saturated molecules and less than 0.03 wt % sulfur. Group II base stocks also have a viscosity index of at least 80 but less than 120. Group III base stocks or base oils contain at least 90 wt % saturated molecules and less than 0.03 wt % sulfur, with a viscosity index of at least 120.

The use of membranes to perform separations in a refinery has been disclosed. Separation of crude oil by membranes was disclosed in U.S. Pat. Nos. 8,845,886 and 8,864,996, and separation of heavy hydrocarbon streams with membranes was disclosed in U.S. Pat. Nos. 5,256,297; 7,736,493; 7,837,879; 7,867,379; 7,871,510; 7,897,828; 7,931,798; 7,943,037; 8,177,965; 8,845,886 and 8,864,996.

For example, U.S. Pat. No. 5,256,297 describes a membrane process to remove metals, CCR, asphaltenes from heavy hydrocarbon feed by ultra-filtering the heavy hydrocarbon feed through multiple ultrafiltration stages operating in series, however it only describes a generic process stream and does not disclose a specific separation process.

U.S. Pat. No. 7,736,493 describes vacuum residue ultrafiltration for improving a deasphalting unit process. In particular, the publication produces an improved quality feedstream to a solvent deasphalting process which results in improved deasphalted oil (DAO) production rates and/or higher quality deasphalted oils, however it does not disclose any details of base stock production or improvements to various properties of a base stock.

U.S. Pat. No. 7,867,379 describes an ultrafiltration process for separating the steam cracker tar constituents and mostly to reduce the MCR content. The process is related to steam cracker tar and not related to base stock production.

U.S. Pat. No. 7,871,510 describes ultrafiltration process to produce an improved coker feed to ultimately produce a substantially free-flowing coke, and the purpose of this publication is to manipulate just the MCR or CCR of the feed stream and not change the range of properties which are needed for base stock production.

U.S. Pat. No. 7,897,828 describes separating a heavy hydrocarbon stream with ultrafiltration, where the feed is mostly vacuum resid and the publications are focused on viscosity, metals, MCR/CCR reduction.

U.S. Pat. No. 8,177,965 provides a method for separating heavy hydrocarbon stream components by molecular species instead of molecular boiling points, while its focus is to allow saturates to go through from a range of whole crudes where the permeate and retentate are fed to an atmospheric or vacuum distillation column or a coker (fluid, flexi or delayed).

In addition, U.S. Patent Application Publication 2017/137350 describes the use of asymmetric membrane structures for hydrocarbon reverse osmosis of small hydrocarbons more specifically the separation of para-xylene from ortho- and meta-xylene, however, its focus is on separation of xylenes and not base stock improvements.

U.S. Patent Application Publications 2017/136420 and 2017/144106 describes the method of making asymmetric carbon membranes and its use in hydrocarbon separations. The publications do not describe the use of membranes for base stock production.

### SUMMARY

According to an embodiment of the invention, a method for producing an improved base stock comprising a separation process is provided, wherein the separation process comprises: a) conducting a hydrocarbon feedstream with an initial boiling point of at least 600° F. (˜316° C.) and/or a final boiling point of no more than 1100° F. (˜593° C.) to a membrane separation zone wherein the feedstream contacts a first side of at least one membrane element, wherein the membrane element has an average pore size from about 0.3 nanometer to about 10 nanometer; b) retrieving at least one retentate product stream from the first side of the membrane element; c) retrieving at least one permeate product stream from a second side of the membrane element; and d) processing at least a portion of the permeate product stream into the base stock having a kinematic viscosity at 100° C. between about 2 to about 35 cSt, a viscosity index (VI) of at least 80, at least 90 wt % saturated molecules and less than 0.03 wt % sulfur.

In a further embodiment, the membrane is selected from a group consisting of organic membranes, inorganic membranes, supported liquid or facilitated transport membranes, hybrid or mixed-matrix membranes, and combinations thereof.

In further embodiment, the hydrocarbon feedstream is selected from a group consisting of deasphalted oil (DAO), vacuum gas oil (VGO), vacuum distillates, intermediate streams, and combinations thereof.

In a further embodiment, an apparatus for producing an improved base stock is provided. The apparatus comprises a separation unit and a hydroprocessing unit, wherein the separation unit comprises a membrane element having an average pore size from about 0.3 nanometer to about 10 nanometer, a retentate zone wherein a hydrocarbon feedstream with an initial boiling point of at least 600° F. and/or a final boiling point of no more than 1100° F. contacts a first side of the membrane element, and a permeate zone from which a permeate stream is obtained from a second side of the membrane element, wherein the permeate is further processed by the hydroprocessing unit into the base stock having a kinematic viscosity at 100° C. between about 2 to about 35 cSt, a viscosity index (VI) of at least 80, at least 90 wt % saturated molecules and less than 0.03 wt % sulfur.

In a further embodiment, the hydroprocessing unit comprises a hydrocracking reactor and a dewaxing reactor.

In a further embodiment, a separation method for producing an improved base stock is provided. The method comprises: a) conducting a base stock having a viscosity index (VI) of less than 120 to a membrane separation zone wherein the feedstream contacts a first side of at least one membrane element, wherein the membrane element has an average pore size from about 0.3 nanometer to about 10 nanometer; b) retrieving at least one retentate product stream from the first side of the membrane element; and c) retrieving at least one permeate product stream from a second side of the membrane element to produce the base stock having a kinematic viscosity at 100° C. between about 2 to about 35 cSt, a viscosity index (VI) of at least 120, at least 90 wt % saturated molecules and less than 0.03 wt % sulfur.

### BRIEF DESCRIPTION OF DRAWINGS

FIG. 1 illustrates an embodiment of the present disclosure using a membrane in a separation process for hydrocarbon feedstream.

FIG. 2 schematically shows an example of a configuration suitable for processing a hydrocarbon feedstream to form an improved base stock.

FIG. 3 schematically shows an example of an apparatus according to an embodiment of the invention.

FIG. 4 schematically shows an example of an apparatus according to an embodiment of the invention.

FIG. 5 schematically shows an example of an apparatus according to an embodiment of the invention.

FIG. 6 schematically shows an example of an apparatus according to an embodiment of the invention.

FIG. 7 schematically shows an example of an apparatus according to an embodiment of the invention.

FIG. 8 shows a Simulated Distillation (SIMDIST) plot showing the reduction in the boiling point of the permeate streams vs. the feed stream.

FIG. 9 shows an example of cumulative permeate yield and permeate rate as a function of time.

FIG. 10 shows a Simulated Distillation (SIMDIST) plot showing the reduction in the boiling point of the permeate streams vs. the feed stream.

FIG. 11 shows an example of cumulative permeate yield and permeate rate as a function of time.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the apparatuses and methods encompassed are not limited to the specific embodiments described below, but rather, include all alternatives, modifications, and equivalents falling within the true spirit and scope of the appended claims.

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” All patents and publications mentioned herein are incorporated by reference in their entirety, unless otherwise indicated. In case of conflict as to the meaning of a term or phrase, the present specification, including explanations of terms, control. Directional terms, such as “upper,” “lower,” “top,” “bottom,” “front,” “back,” “vertical,” and “horizontal,” are used herein to express and clarify the relationship between various elements. It should be understood that such terms do not denote absolute orientation (e.g., a “vertical” component can become horizontal by rotating the device). The materials, methods, and examples recited herein are illustrative only and not intended to be limiting.

The term “raw crude” as used herein, means unrefined crude oil. The term “HDW” as used herein means hydrodewaxing, which can be interchangeably with “catalytic dewaxing” or “isomerization” in the present disclosure. The term “average boiling point” as used herein is defined as the mass weighted average boiling point of the molecules in a mixture. This may be determined by simulated distillation gas chromatography (also referred to herein as “SIMDIS”). The term “final boiling point” is defined as the temperature at which 95 wt % of the mixture is volatized at atmospheric (standard) pressure. Boiling points, including fractional weight boiling points, can be determined using an appropriate ASTM test method, such as the procedures described in ASTM D2887, D2892, D6352, D7129, and/or D86.

Unless otherwise noted, the term “hydrocarbon feedstream” or “hydrocarbon stream” as used herein is defined as a fluid stream that is comprised at least 80% hydrocarbon containing compounds by weight percentage. The naphtha boiling range is defined as 50° F. (˜10° C., roughly corresponding to the lowest boiling point of a pentane isomer) to 315° F. (157° C.). The jet boiling range is defined as 315° F. (157° C.) to 460° F. (238° C.). The diesel boiling range is defined as 460° F. (238° C.) to 650° F. (343° C.). The distillate fuel boiling range (jet plus diesel), is defined as 315° F. (157° C.) to 650° F. (343° C.). The fuels boiling range is defined as ˜10° C. to 343° C. The lubricant boiling range is defined as 650° F. (343° C.) to 1050° F. (566° C.). Optionally, when forming a lubricant boiling portion by fractionation after one or more stages of hydroprocessing (e.g., hydrotreating, hydrocracking, catalytic dewaxing, hydrofinishing), a lubricant boiling range portion can optionally correspond to a bottoms fraction, so that higher boiling range compounds may also be included in the lubricant boiling range portion. Compounds (C₄₋) with a boiling point below the naphtha boiling range can be referred to as light ends. It is noted that due to practical consideration during fractionation (or other boiling point based separation) of hydrocarbon-like fractions, a fuel fraction formed according to the methods described herein may have T5 and T95 distillation points corresponding to the above values (or T10 and T90 distillation points), as opposed to having initial/final boiling points corresponding to the above values.

The present inventors discovered a method that unexpectedly producesbase stocks with improved properties, such as lower aromatics and naphthenes, improved viscosity index, reduced hetro atoms or polar molecules like sulfur or nitrogen, improved low temperature viscometrics and color. The present disclosure provides a method to produce such improved base stock utilizing a membrane with smaller pore size and lower molecular weight cut-off from hydrocarbon feedstream including de-asphalted oil (DAO), vacuum gas oil (VGO), distillates, intermediate streams in the catalytic or solvent based routes, and Group I or II base stocks.

### Hydrocarbon Feedstreams

A wide range of petroleum and chemical hydrocarbon feedstreams can be used for the present disclosure. Suitable hydrocarbon feedstreams include whole and reduced petroleum crudes, atmospheric, cycle oils, gas oils, including vacuum gas oils and coker gas oils, light to heavy distillates including raw virgin distillates, hydrocrackates, hydrotreated oils, petroleum-derived waxes (including slack waxes), Fischer-Tropsch waxes, raffinates, deasphalted oils, and mixtures of these materials.

In some embodiments, the hydrocarbon feedstreams are deasphalted oil (DAO), vacuum gas oil (VGO), vacuum distillates, intermediate streams, or combinations thereof. In some embodiments, the hydrocarbon feedstreams are hydroprocessed VGO/distillate/DAO, or combinations thereof. In some embodiments, the hydrocarbon feedstreams are Group I or II base stocks.

One option for defining a boiling range of hydrocarbon feedstreams is to use an initial boiling point for a hydrocarbon feedstream and/or a final boiling point for a hydrocarbon feedstream. Another option is to characterize a hydrocarbon feedstream based on the amount of the hydrocarbon feedstream that boils at one or more temperatures. For example, a “T5” boiling point/distillation point for a hydrocarbon feedstream is defined as the temperature at which 5 wt % of the hydrocarbon feedstream will boil off. Similarly, a “T95” boiling point/distillation point is a temperature at 95 wt % of the hydrocarbon feedstream will boil. Boiling points, including fractional weight boiling points, can be determined using an appropriate ASTM test method, such as the procedures described in ASTM D2887, D2892, D6352, D7129, and/or D86.

Hydrocarbon feedstreams contemplated by the present invention in various embodiments include, for example, hydrocarbon feedstreams with an initial boiling point or a T5 boiling point or T10 boiling point of at least 600° F. (˜316° C.), or at least 650° F. (˜343° C.), or at least 700° F. (371° C.), or at least 750° F. (˜399° C.). Additionally or alternately, the final boiling point or T95 boiling point or T90 boiling point of the hydrocarbon feedstreams can be 1100° F. (˜593° C.) or less, or 1050° F. (˜566° C.) or less, or 1000° F. (˜538° C.) or less, or 950° F. (˜510° C.) or less. In particular, a hydrocarbon feedstream can have a T5 boiling point of at least 600° F. (˜316° C.) and a T95 boiling point of 1100° F. (˜593° C.) or less, or a T5 boiling point of at least 650° F. (˜343° C.) and a T95 boiling point of 1050° F. (˜566° C.) or less, or a T10 boiling point of at least 650° F. (˜343° C.) and a T90 boiling point of 1050° F. (˜566° C.) or less. Optionally, if the hydroprocessing is also used to form fuels, it can be possible to use a hydrocarbon feedstream that includes a lower boiling range portion. Such a hydrocarbon feedstream can have an initial boiling point or a T5 boiling point or T10 boiling point of at least 350° F. (˜177° C.), or at least 400° F. (˜204° C.), or at least 450° F. (˜232° C.). In particular, such a hydrocarbon feedstream can have a T5 boiling point of at least 350° F. (˜177° C.) and a T95 boiling point of 1100° F. (˜593° C.) or less, or a T5 boiling point of at least 450° F. (˜232° C.) and a T95 boiling point of 1050° F. (˜566° C.) or less, or a T10 boiling point of at least 350° F. (˜177° C.) and a T90 boiling point of 1050° F. (˜566° C.) or less.

In some aspects, the aromatics content of the hydrocarbon feedstream can be at least 20 wt %, or at least 25 wt %, or at least 30 wt %, or at least 40 wt %, or at least 50 wt %, or at least 60 wt %, such as up to 75 wt % or up to 90 wt %. In particular, the aromatics content can be 25 wt % to 75 wt %, or 25 wt % to 90 wt %, or 35 wt % to 75 wt %, or 35 wt % to 90 wt %. In other aspects, the feed can have a lower aromatics content, such as an aromatics content of 35 wt % or less, or 25 wt % or less, such as down to 0 wt %. In particular, the aromatics content can be 0 wt % to 35 wt %, or 0 wt % to 25 wt %, or 5.0 wt % to 35 wt %, or 5.0 wt % to 25 wt %. In an embodiment, the hydrocarbon feedstream has an aromatics content of about 25 wt % to about 75 wt %.

In aspects where the hydroprocessing includes a hydrotreatment process and/or a sour hydrocracking process, the hydrocarbon feedstreams can have a sulfur content of 500 wppm to 20000 wppm or more, or 500 wppm to 10000 wppm, or 500 wppm to 5000 wppm. Additionally or alternately, the nitrogen content of such a hydrocarbon feedstream can be 20 wppm to 4000 wppm, or 50 wppm to 2000 wppm. In some aspects, the hydrocarbon feedstream can correspond to a “sweet” hydrocarbon feedstream, so that the sulfur content of the hydrocarbon feedstream is 10 wppm to 500 wppm and/or the nitrogen content is 1 wppm to 100 wppm.

In some embodiments, at least a portion of the hydrocarbon feedstream can correspond to a hydrocarbon feedstream derived from a biocomponent source. In this discussion, a biocomponent feedstock refers to a hydrocarbon feedstock derived from a biological raw material component, from biocomponent sources such as vegetable, animal, fish, and/or algae. Note that, for the purposes of this document, vegetable fats/oils refer generally to any plant based material, and can include fat/oils derived from a source such as plants of the genus Jatropha. Generally, the biocomponent sources can include vegetable fats/oils, animal fats/oils, fish oils, pyrolysis oils, and algae lipids/oils, as well as components of such materials, and in some embodiments can specifically include one or more type of lipid compounds. Lipid compounds are typically biological compounds that are insoluble in water, but soluble in nonpolar (or fat) solvents. Non-limiting examples of such solvents include alcohols, ethers, chloroform, alkyl acetates, benzene, and combinations thereof.

The permeate product stream from the membrane can have various improved properties including: improved viscosity index, reduced hetro atoms or polar molecules like sulfur or nitrogen, improved wax content, reduced Microcarbon Residue and metals content, increased paraffinic (n- and iso-) and 1,2 ring naphthenes and 1,2 ring aromatics, reduced 3+ ring Naphthenes and 3+ ring aromatics, and improved pour point and color.

In some embodiments, the permeate product retains about at least 80%, e.g. at least 85%, at least 90%, or 80-100%, 80-95%, 85-95%, of all saturates and at least 80%, e.g. at least 85%, at least 90%, or 80-100%, 80-95%, 90-99%, of all paraffins from the incoming hydrocarbon feedstream. The permeate stream as compared to the hydrocarbon feedstream is reduced in aromatics content by at least 30%, e.g. at least 40%, at least 70%, or 30-80%, 40-80% or 50-80% and other ringed molecules by at least 20%, e.g. at least 30%, at least 40%, or 20-60%, 30-50% or 40-50%. In a embodiment, the permeate product stream has an aromatics content of about 25 wt % to about 75 wt %. The permeate stream is even more selective for lower molecular weight (less than 250) molecules. About 90-99% of saturates and paraffins with molecular weights less than 250 are retained in the permeate product from the hydrocarbon feedstream. Conversely, higher molecular weight (greater than 500) molecules are scarce in the permeate stream. Only about 15-35% of aromatics and other ringed molecules with a molecular weight greater than 500 are retained in the permeate stream from the hydrocarbon feedstream. Although all of the percentages above are to the permeate stream, it would be understood by a person of skill in the art that the complimentary percentages would apply to the retentate stream, i.e. 85% in the permeate would correspond to 15% in the retentate, and so on.

### Membranes

The term “membrane” as used herein, refers to organic membranes (for example, polymeric membranes); inorganic membranes (for example, metallic, silica, ceramic, carbon, graphene, zeolite, MOF, oxide, glass membranes and combinations of any of the foregoing, without limitation); supported-liquid or facilitated transport membranes; hybrid or mixed-matrix membranes comprised of inorganic particles (for example, zeolite, carbon, metal, metal oxides and combinations of any of the foregoing, without limitation) as the dispersed phase and a polymer matrix as the continuous phase materials, and combinations thereof.

According to an embodiment, the membrane is a polymeric membrane, a ceramic membrane, a sintered metal membrane, a porous glass membrane, or a combination thereof.

In some embodiments, the polymeric membranes include a polymer, for example, a homopolymer, a copolymer, a polymer blend, or combinations thereof. The polymer may be selected from, e.g., cellulose acetate (CA), polysulfones regenerated cellulose, cellulose triacetate, polyether sulfones, polyetherimide, polyvinylidenefluoride, aromatic polyamides, aliphatic polyamides, polyimides, polyamide-imides, polyetherimides, polyetheresters, polysulfones, polybenzimidazoles, polybenzoxazoles, polyacrylonitrile, polyaromaticpolyamide imides, polyamide esters, polyesters, perfluoropolymers, etc., and combinations, copolymers, and substituted polymers thereof . . . nitrile rubber, neoprene, polydimethylsiloxane and related silicone polymers, chlorosulfonated polyethylene, polysilicone-carbonate copolymers, fluoroelastomers, plasticized polyvinylchloride, polyurethane, cis-polybutadiene, cis-polyisoprene, poly(butene-1), polystyrene-butadiene copolymers, polyamide-polyether block copolymers, styrene/butadiene/styrene block copolymers, styrene/ethylene/butylene block copolymers, and thermoplastic polyolefin elastomers.

In various embodiments, the membrane is a symmetric polymeric membrane, an asymmetric polymeric membrane or a combination of both. According to an embodiment, the polymeric membrane is asymmetric. The asymmetric polymeric membrane has a thin selective layer having a thickness of less than 10 μm, or less than 2 μm, or less than 1 μm, or, alternatively, in the range of 100 nm nm to 1 μm, or 300 nm to 700 nm, according to various embodiments. According to an embodiment, the membrane is an asymmetric polyimide polymeric membrane.

In various embodiments, the membrane is a thin film composite membrane with a thin selective layer having a thickness of less than 10 μm, or less than 2 μm, or less than 1 μm or, alternatively, in the range of 100 nm to 1 μm, or 300 nm to 700 nm, according to various embodiments. According to an embodiment, the membrane has a selective layer comprising cross-linked silicone cast on a porous support layer fabricated of polyimide polymer. According to an embodiment, the membrane has a selective layer comprising cross-linked silicone cast on a porous support layer fabricated of polyether imide polymer.

The term “ceramic” as utilized herein is defined as any hard, brittle, heat-resistant and corrosion-resistant material made by mixing, shaping and then firing to elevated temperatures a nonmetallic mineral or combination of minerals. Some examples of ceramics and ceramic membrane modules that can be used in the present disclosure include, but are not limited to, monoliths, membranes, tubes, discs, sheets, layered structures, and other geometrical configurations known to those well versed in the state of the art. Ceramics as used in the present disclosure are selected from materials comprised from clays, titania, silica, alumina, cordierite, ferric oxide, boron nitride, zirconia, zeolitic materials, glass, silicon carbide, layered mineral structures, kaolinite, earthen ware materials, SO₂/Fe₂O₃, composites, layered structures comprising a combination of materials, foamed structures comprising a combination of materials, honey-combed configurations comprising a combination of materials, silicon nitride, solgel materials, steatite, porcelain, perovskites, macroporous and mesoporous materials, carbons, mixed matrix materials, and combinations thereof. Most preferably, the ceramics as used in the present disclosure are selected from materials comprised from clays, titania, silica, alumina, cordierite, ferric oxide, boron nitride, zirconia, zeolitic materials, glass, and silicon carbide. The ceramic membranes disclosed herein may also be functionalized as described in U.S. Pat. No. 8,845,886 which is incorporated by reference in its entirety. According to various embodiments, the ceramic membrane has a thickness in a range of 0.5-10 mm, or 1 to 8 mm, or 1 to 6 mm, or 2 to 5 mm, or 2.5 to 4.5 mm, and is made up of TiO₂ support layer and a TiO₂ selective layer. The support layer is about from 50%, or 60%, or 70% to about 80%, or 90%, or 95% by volume of the membrane and the selective layer is the remainder.

Form factor of the membranes can be flat sheet, spiral wound, tubular, hollow fiber, monolithic (multi-channel), coated tube, composite membrane configurations, or combinations thereof.

The membranes of the present invention have a pore size of about 0.2 nm to about 100 nm. According to various embodiments, the membranes have a pore size of 0.2 nm to 80 nm, or 0.2 nm to 70 nm, or 0.2 nm to 60 nm, or 0.2 nm to 50 nm, or 0.2 nm to 40 nm, or 0.25 nm to 30 nm, or 0.25 nm to 20 nm, or 0.25 nm to 15 nm, or 0.3 nm to 10 nm, or 0.3 nm to 2 nm. When measured in kilodaltons, the present invention contemplates membranes with a pore size of 0.01 kD to about 800 kD. According to various embodiments, the membranes have a pore size of 0.02 kD to about 700 kD, or 0.03 kD to about 600 kD, or 0.04 kD to about 500 kD, or 0.05 kD to about 400 kD, or 0.06 kD to about 300 kD, or 0.08 kD to about 200 kD, or 0.09 kD to about 200 kD, or 0.1 kD to about 200 kD, or 0.1 kD to about 100 kD, or 0.1 kD to about 50 kD, or 0.1 kD to 8 kD. The present invention contemplates membranes of any diameter. For example, the diameter may be selected based upon suitability for various uses such as commercial use or research use. The diameter may also be selected in accordance with According to various embodiments, the membranes have a diameter of at least 20 mm, at least 30 mm, or at least 40 mm. According to various embodiments, the membranes have a diameter in a range of from 20 to 90 mm, or from 30 to 80 mm, or from 40 to 70 mm, or from 40 to 60 mm or from 40 to 50 mm.

According to an embodiment, the membranes allow molecules to pass through the pores based on its size, for example, 3+ ring aromatics or naphthenes could get rejected while a 1,2 ring aromatic or naphthene could pass through or a paraffinic molecule could as well. Alternatively, a membrane could allow molecules to pass based on its solubility or aromaticity. In this case a non-aromatic molecule like a paraffin or naphthene could be rejected while a large aromatic molecule could pass through the membrane. Either type of membrane could be used here. If a size based separating membrane is used, the permeate is the desired product, and if a solubility based separating membrane is used, the retentate is the desired product.

According to various embodiments, the permeate has an aromatics content of about at least 10 wt %, or at least 20 wt %, or at least 30 wt %, or at least 40 wt %, or at least 50 wt %, or at least 60 wt %, or at least 70 wt %, or in a range of about 10 wt %, or 15 wt %, or 20 wt %, or 25 wt %, or 30 wt %, or 35 wt %, or 40 wt % to about 50 wt %, or 55 wt %, or 60 wt %, or 65 wt %, or 70 wt %, or 75 wt %, or 80 wt %, or 85 wt %, or 90 wt %, or 95 wt %.

According to certain embodiments of the present invention, the pressure across the membrane is about 10 psi to about 3000 psi, or about 20 psi to about 3000 psi, or about 50 psi to about 3000 psi, or about 100 psi to about 2000 psi, or about 150 psi to about 2000 psi, or about 150 psi to about 1500 psi, or about 200 psi to about 1000 psi, particularly when the hydrocarbon feedstream is comprised of heavy hydrocarbon components. According to various embodiments, the pressure across the membrane is at least 400 psi, for example, at least 7000 psi, or at least 6000 psi, or at least 5000 psi, or at least 4000 psi, or at least 3000 psi, or at least 2000 psi, or at least 1500 psi. In an embodiment, the pressure across the membrane (or pressure drop) for operation of the present disclosure is about 400 to about 3000 psi, for example, about 500 to about 2500 psi, or about 700 to about 1500 psi.

According to various embodiments of the present invention, the operating temperature of the membranes is from 20° C. to 350-400° C. According to certain embodiments, the operating temperature of the membranes is at least 60° C. (for example, where the wax in the permeate melts at ˜60° C.), for example, the operating temperature of the membranes is about 60° C. to about 400° C., or about 60° C. to about 300° C., or about 70° C. to about 300° C.

Trans-membrane pressure can be 1-1500 psig, or 10-1200 psig, or 50-1000 psig, or 100-1000 psig, or 150-900 psig, or 200-800 psig. Higher pressure helps with improving the flux and also higher selectivity. However, there is a practical limitation on how high you can take the trans-membrane pressure up to 120 Bar or 1800 psig.

Flux through the membrane can vary depending on the membrane pore size and test conditions. We have found the flux to be in the range of 1-5 gallons/ft² day. The flux can be as high as 20 gallons/ft² day.

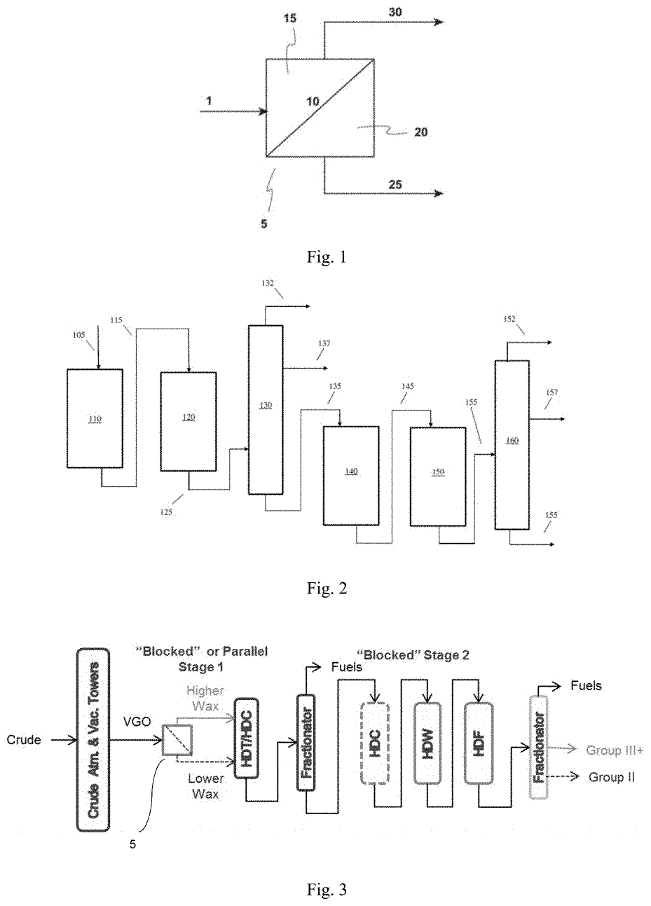

A separation process utilizing the membranes comprises: i) contacting the feedstock on a first side of the membrane; ii) retrieving the retentate stream from the first side of the membrane, and retrieving the permeate stream from a second side of the membrane. An embodiment of the separation process for hydrocarbon feedstream utilizing a membrane is illustrated in FIG. 1. Here, a hydrocarbon feedstream (1) is fed to a separation unit (5) which contains one or more membrane elements and support elements to hold the membrane(s) in place as well as openings and/or conduits, such as at least an inlet and two outlets, to allow the feedstream to contact the membrane elements and for the retentate stream and the permeate stream to be conducted away from the separation unit for subsequent processing. In certain embodiments, the hydrocarbon feedstream (1) has an initial boiling point of at least 600° F. (˜316° C.) and/or a final boiling point of no more than 1100° F. (˜593° C.). The separation unit (5) contains a membrane element (10), a retentate zone (15) wherein the hydrocarbon feedstream (1) contacts a first side of membrane (10), and a permeate zone (20), from which at least one permeate stream (25) is obtained from the opposite or second side of membrane (10). Such permeate stream (25) obtained is comprised of materials that selectively permeate through the membrane element (10). In certain embodiments, the hydrocarbon feedstream may be flowed across the face of the membrane element(s) in a “cross-flow” configuration. In this configuration, in the retentate zone (15), the hydrocarbon feedstream (1) contacts one end of the membrane element (10) and flows across the membrane, while a retentate product stream (30) is withdrawn from the other end of the retentate zone (15). As the feedstream/retentate flows across the face of the membrane, a composition selective in saturated compounds content flows through the membrane to the permeate zone (20) wherein it is drawn off as a permeate stream (25). In a cross-flow configuration, it is preferable that the Reynolds number in at least one retentate zone (15) of the membrane separations unit (5) be in the turbulent range, preferably above about 2000, and more preferably, above about 4000. In some embodiments, a portion of a retentate stream obtained from the membrane separation units may be recycled and mixed with the feedstream to the membrane separations unit prior to contacting the active membrane.

Continuing with FIG. 1, the present disclosure utilizes a separation process to separate the feedstream into at least one permeate product stream (25) and at least one retentate product stream (30) is drawn from the retentate zone (15) of the separation unit (5). It should be understood that depending upon more complex arrangements such as multiple internal stages, series or parallel multiple unit operations, and/or separation unit configurations knowledgeable to those skilled in the art, that more than one membrane element and/or separation zone may be utilized and that more than one permeate stream and/or retentate stream may be obtained from the separation unit (5). Additionally, the retentate stream (30), permeate product stream (25) or any portions thereof may be recycled to the primary retentate zone or any intermediate retentate zone.

The membranes may be positioned in a single membrane unit (stage) or in several units, wherein each unit may be comprised of one or more separate membranes. Typically, the number of membrane units may depend on the surface area of the separate membranes in combination with the required quantity of steam to be permeated. The membrane units may include membranes of the same type, or a different type, in terms of composition or configuration. As a consequence, the membrane units may differ from each other, in terms of one or more of shape, permeance, permselectivity, or surface area available for permeation. Furthermore, the membranes may be arranged in series or in parallel, for example.

### Base Stocks

The improved base stocks have the following improved properties, such as having a kinematic viscosity at 100° C. between about 0.5 to about 40 cSt, or about 1 to about 35 cSt, or about 1.5 to about 35 cSt, or about 2 to about 35 cSt, having a viscosity index at least 80, or at least 90, or at least 100, or at least 110, or at least 120, or at least 130, or at least 140, or at least 150, having at least 50 wt %, or at least 55 wt %, or at least 60 wt %, or least 70 wt %, or at least 80 wt %, or at least 90 wt %, or at least 95 wt %, or at least 97 wt %, or at least 99 wt % or at least 99.9 wt % or at least 99.99 wt % saturated molecules, and having less than less than 0.5 wt %, or 0.2 wt %, or 0.1 wt %, or 0.08 wt %, or 0.06 wt %, or 0.05 wt %, or 0.03 wt %, or 0.01 wt % sulfur, according to various embodiments.

In some aspects, the total aromatics content of the improved base stocks is 2.0 wt % or less, or 1.5 wt % or less, or 1.0 wt % or less, or 0.5 wt % or less, or 0.3 wt % or less, or 0.1 wt % or less, or substantially free of aromatics. In various aspects, the 3+ ring aromatics content is 0.2 wt % or less, or 0.1 wt % or less, or 0.05 wt % or less, or substantially free of aromatics. In an embodiment, the base stock has a total aromatics content of 2.0 wt % or less, a 3+ ring aromatics content of 0.2 wt % or less, or a combination thereof.

In some aspects, the improved base stocks of the present disclosure can be a Group III base stock, which may include a Group III+ base stock. Although a generally accepted definition is not available, a Group III+ base stock can generally correspond to a base stock that satisfies the requirements for a Group III base stock while also having at least one property that is enhanced relative to a Group III specification. The enhanced property can correspond to, for example, having a viscosity index that is substantially greater than the required specification of 120, such as a Group III base stock having a VI of at least 130, or at least 135, or at least 140.

In the present disclosure, the permeate stream can be converted into an improved base stock either through solvent process or hydroprocessing process.

### Hydroprocessing Processes

FIG. 2 shows an example of a general processing configuration suitable for processing a feedstock to form a base stock. In FIG. 2, a hydrocarbon feedstream 105 can be introduced into a first reactor 110. A reactor such as first reactor 110 can include a feed inlet and an effluent outlet. First reactor 110 can correspond to a hydrotreating reactor, a hydrocracking reactor, or a combination thereof. Optionally, a plurality of reactors can be used to allow for selection of different conditions. For example, if both a first reactor 110 and optional second reactor 120 are included in the apparatus, first reactor 110 can correspond to a hydrotreatment reactor while second reactor 120 can correspond to a hydrocracking reactor. Yet other options for arranging reactor(s) and/or catalysts within the reactor(s) to perform initial hydrotreating and/or hydrocracking of a hydrocarbon feedstream can also be used. Optionally, if a configuration includes multiple reactors in the initial stage, a gas-liquid separation can be performed between reactors to allow for removal of light ends and contaminant gases. In aspects where the initial stage includes a hydrocracking reactor, the hydrocracking reactor in the initial stage can be referred to as an additional hydrocracking reactor.

The hydroprocessed effluent 125 from the final reactor (such as reactor 120) of the initial stage can then be passed into a fractionator 130, or another type of separation stage. Fractionator 130 (or other separation stage) can separate the hydroprocessed effluent to form one or more fuel boiling range fractions 137, a light ends fraction 132, and a hydrocarbon fraction 135. The hydrocarbon fraction 135 can often correspond to a bottoms fraction from the fractionator 130. The hydrocarbon feedstream fraction 135 can undergo further hydrocracking in second stage hydrocracking reactor 140. The effluent 145 from second stage hydrocracking reactor 140 can then be passed into a dewaxing/hydrofinishing reactor 150 to further improve the properties of the eventually produced base stocks. In the configuration shown in FIG. 2, the effluent 155 from second stage dewaxing/hydrofinishing reactor 150 can be fractionated 160 to separate out light ends 152 and/or fuel fraction(s) 157 from one or more desired lubricant base stock product fractions 155, which can be further separated into different base stock products.

The configuration in FIG. 2 can allow the second stage hydrocracking reactor 140 and the dewaxing/hydrofinishing reactor 150 to be operated under sweet processing conditions, corresponding to the equivalent of a feed (to the second stage) sulfur content of 100 wppm or less. Under such “sweet” processing conditions, the configuration in FIG. 2 can allow for production of a hydrocracked effluent having a reduced or minimized content of aromatics.

In the configuration shown in FIG. 2, the final reactor (such as reactor 120) in the initial stage can be referred to as being in direct fluid communication with an inlet to the fractionator 130 (or an inlet to another type of separation stage). The other reactors in the initial stage can be referred to as being in indirect fluid communication with the inlet to the separation stage, based on the indirect fluid communication provided by the final reactor in the initial stage. The reactors in the initial stage can generally be referred to as being in fluid communication with the separation stage, based on either direct fluid communication or indirect fluid communication. In some optional aspects, one or more recycle loops can be included as part of an apparatus configuration. Recycle loops can allow for quenching of effluents between reactors/stages as well as quenching within a reactor/stage.

FIG. 3 illustrates an example of a two-stage apparatus for VGO portioning via a membrane, where the two hydrocracking processes (HDC) are optional. After a hydrocarbon feedstream containing at least a portion that is a VGO is separated from crude via a vacuum distillation, the feedstream containing VGO is directed to the separation unit (5). In the separation unit (5), the hydrocarbon feedstream containingVGOis separated into a higher waxy phase and lower waxy phase utilizing a membrane prior to hydroprocessing (such as hydrocracking, hydrotreating, and hydrodewaxing) and separation in stage 1 and/or stage 2 to produce base stocks such as Group II and/or Group III base stocks (including Group II+ and/or Group III+) base stocks.

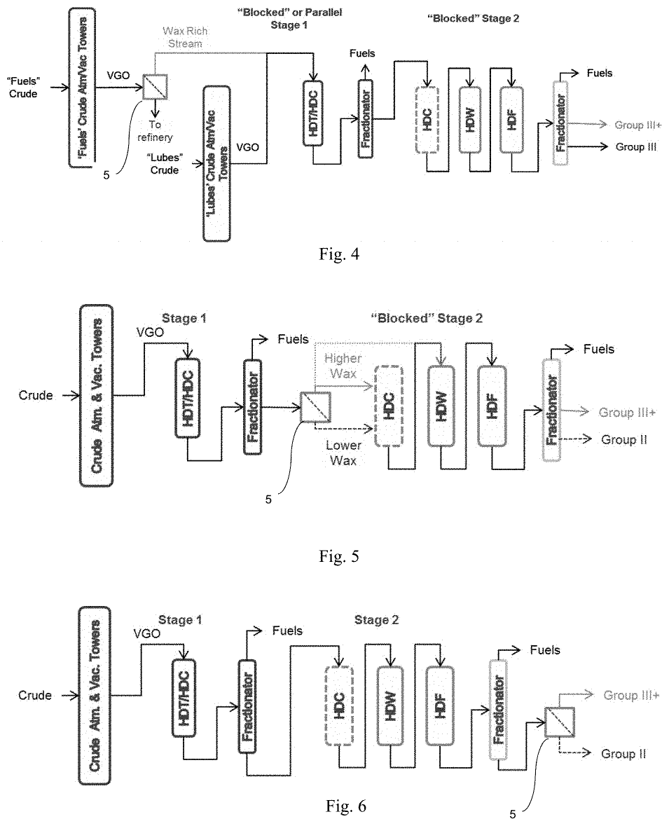

FIG. 4 illustrates an example of a two-stage apparatus for wax skimming VGO from “fuels” crudes meaning crudes that typically would not allow for production of lubricant base stocks or would not produce base stocks at a high enough yield to be economically viable. After a hydrocarbon feedstream containing at least a portion that is a VGO is separated from a fuels crude via a vacuum distillation, the feedstream containing VGO is directed to the separation unit (5). The hydrocarbon feedstream directed to the separation unit (5) is separated into a wax rich stream utilizing a membrane prior to hydroprocessing in stage 1 and/or stage 2 to produce base stock(s). 1.

FIG. 5 illustrates an example of a two-stage apparatus for hydrotreated product partitioning, where the hydrotreated VGO is separated into higher waxy phase utilizing a membrane after hydroprocessing in stage 1 and prior to hydroprocessing in stage 2. After stage 1, a hydrocarbon stream is directed to the separation unit (5), and then subsequently processed in stage 2 to produce base stock(s).

FIG. 6 provides an example of a two-stage apparatus for base stock portioning. The resultant base stocks from stage 2 are are directed to a separation unit (5) and separated into Group II and Group III+ base stocks utilizing a membrane.

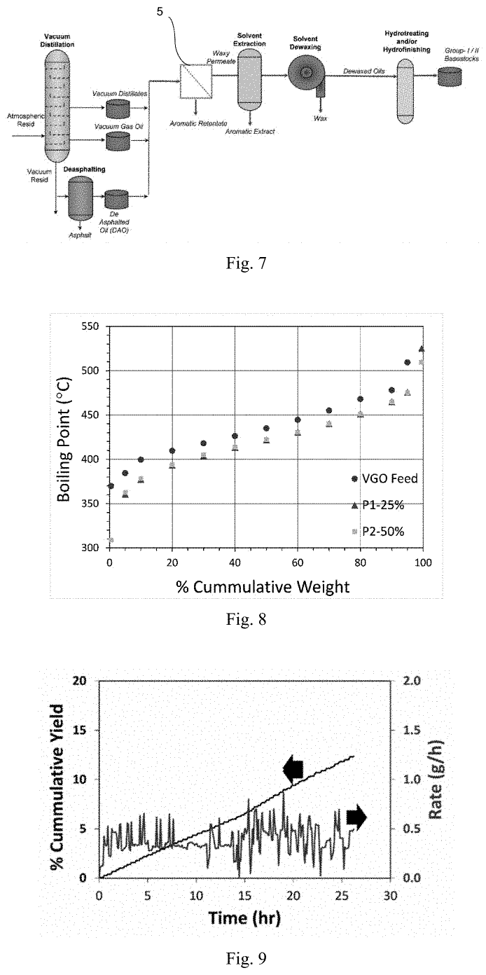

FIG. 7 provides an example where the membrane is used in a solvent based flow scheme. VGO or DAO is fed to a membrane in a separation unit (5) and the more waxy permeate stream is then sent to further aromatic extraction followed by solvent dewaxing and hydrotreating or hydrofinishing to produce Group I and/or Group II base stocks. The aromatic rich retentate stream can be sent back to the refinery for further processing or can be blended into mogas or motor gasoline pool.

In the present disclosure, conditions may be provided for various types of hydroprocessing of feeds or effluents. Examples of hydroprocessing can include, but are not limited to, one or more of hydrotreating, hydrocracking, catalytic dewaxing, and hydrofinishing. Such hydroprocessing conditions can be controlled to have desired values for the conditions (e.g., temperature, pressure, LHSV, treat gas rate) by using at least one controller, such as a plurality of controllers, to control one or more of the hydroprocessing conditions. In some aspects, for a given type of hydroprocessing, at least one controller can be associated with each type of hydroprocessing condition. In some aspects, one or more of the hydroprocessing conditions can be controlled by an associated controller. Examples of structures that can be controlled by a controller can include, but are not limited to, valves that control a flow rate, a pressure, or a combination thereof; heat exchangers and/or heaters that control a temperature; and one or more flow meters and one or more associated valves that control relative flow rates of at least two flows. Such controllers can optionally include a controller feedback loop including at least a processor, a detector for detecting a value of a control variable (e.g., temperature, pressure, flow rate, and a processor output for controlling the value of a manipulated variable (e.g., changing the position of a valve, increasing or decreasing the duty cycle and/or temperature for a heater). Optionally, at least one hydroprocessing condition for a given type of hydroprocessing may not have an associated controller. In some embodiments, the hydroprocessing process in this disclosure comprises a first hydroprocessing stage and a second hydroprocessing stage.

Initial Stage—Hydrotreating and/or Hydrocracking

In various aspects, an initial hydroprocessing stage, which is an optional stage for the present disclosure, can be used to improve one or more qualities of a feedstock for lubricant base stock production. Examples of improvements of a hydrocarbon feedstream can include, but are not limited to, reducing the heteroatom content of a feed, performing conversion on a feed to provide viscosity index uplift, and/or performing aromatic saturation on a feed.

With regard to heteroatom removal, the conditions in the initial hydroprocessing stage (hydrotreating and/or hydrocracking) can be sufficient to reduce the sulfur content of the hydroprocessed effluent to 250 wppm or less, or 200 wppm or less, or 150 wppm or less, or 100 wppm or less, or 50 wppm or less, or 25 wppm or less, or 10 wppm or less. In particular, the sulfur content of the hydroprocessed effluent can be 1 wppm to 250 wppm, or 1 wppm to 50 wppm, or 1 wppm to 10 wppm. Additionally or alternately, the conditions in the initial hydroprocessing stage can be sufficient to reduce the nitrogen content to 100 wppm or less, or 50 wppm or less, or 25 wppm or less, or 10 wppm or less. In particular, the nitrogen content can be 1 wppm to 100 wppm, or 1 wppm to 25 wppm, or 1 wppm to 10 wppm.

In aspects that include hydrotreating as part of the initial hydroprocessing stage, the hydrotreating catalyst can comprise any suitable hydrotreating catalyst, e.g., a catalyst comprising at least one Group 8-10 non-noble metal (for example selected from Ni, Co, and a combination thereof) and at least one Group 6 metal (for example selected from Mo, W, and a combination thereof), optionally including a suitable support and/or filler material (e.g., comprising alumina, silica, titania, zirconia, or a combination thereof). The hydrotreating catalyst according to aspects of the present disclosure can be a bulk catalyst or a supported catalyst. Techniques for producing supported catalysts are well known in the art. Techniques for producing bulk metal catalyst particles are known and have been previously described, for example in U.S. Pat. No. 6,162,350, which is hereby incorporated by reference. Bulk metal catalyst particles can be made via methods where all of the metal catalyst precursors are in solution, or via methods where at least one of the precursors is in at least partly in solid form, optionally but preferably while at least another one of the precursors is provided only in a solution form. Providing a metal precursor at least partly in solid form can be achieved, for example, by providing a solution of the metal precursor that also includes solid and/or precipitated metal in the solution, such as in the form of suspended particles. By way of illustration, some examples of suitable hydrotreating catalysts are described in one or more of U.S. Pat. Nos. 6,156,695, 6,162,350, 6,299,760, 6,582,590, 6,712,955, 6,783,663, 6,863,803, 6,929,738, 7,229,548, 7,288,182, 7,410,924, and 7,544,632, U.S. Patent Applications 2005/0277545, 2006/0060502, 2007/0084754, and 2008/0132407, and International Publications WO 04/007646, WO 2007/084437, WO 2007/084438, WO 2007/084439, and WO 2007/084471, which are incorporated by reference in their entirety. Metal catalysts include cobalt/molybdenum (1-10% Co as oxide, 10-40% Mo as oxide), nickel/molybdenum (1-10% Ni as oxide, 10-40% Co as oxide), or nickel/tungsten (1-10% Ni as oxide, 10-40% W as oxide) on alumina.

In various aspects, hydrotreating conditions can include temperatures of 200° C. to 450° C., or 315° C. to 425° C.; pressures of 250 psi (˜1.8 MPa) to 5000 psi (˜34.6 MPa) or 500 psi (˜3.4 MPa) to 3000 psi (˜20.8 MPa), or 800 psi (˜5.5 MPa) to 2500 psi (˜17.2 MPa); Liquid Hourly Space Velocities (LHSV) of 0.2-10 h⁻¹; and hydrogen treat rates of 200 scf/B (35.6 m³/m³) to 10,000 scf/B (1781 m³/m³), or 500 (89 m³/m³) to 10,000 scf/B (1781 m³/m³).

Hydrotreating catalysts are typically those containing Group 6 metals, and non-noble Group 8-10 metals, i.e., iron, cobalt and nickel and mixtures thereof. These metals or mixtures of metals are typically present as oxides or sulfides on refractory metal oxide supports. Suitable metal oxide supports include low acidic oxides such as silica, alumina or titania, preferably alumina. In some aspects, aluminas can correspond to porous aluminas such as gamma or eta having average pore sizes from 50 to 200 Å, or 75 to 150 Å; a surface area from 100 to 300 m2/g, or 150 to 250 m2/g; and/or a pore volume of from 0.25 to 1.0 cm3/g, or 0.35 to 0.8 cm3/g. The supports are preferably not promoted with a halogen such as fluorine as this generally increases the acidity of the support.

Alternatively, the hydrotreating catalyst can be a bulk metal catalyst, or a combination of stacked beds of supported and bulk metal catalyst. By bulk metal, it is meant that the catalysts are unsupported wherein the bulk catalyst particles comprise 30-100 wt. % of at least one Group 8-10 non-noble metal and at least one Group 6 metal, based on the total weight of the bulk catalyst particles, calculated as metal oxides and wherein the bulk catalyst particles have a surface area of at least 10 m2/g. The bulk metal hydrotreating catalysts used herein comprise 50 to 100 wt %, and even more preferably 70 to 100 wt %, of at least one Group 8-10 non-noble metal and at least one Group 6 metal, based on the total weight of the particles, calculated as metal oxides.

Bulk catalyst compositions comprising one Group 8-10 non-noble metal and two Group 6 metals are preferred. It has been found that in this case, the bulk catalyst particles are sintering-resistant. Thus the active surface area of the bulk catalyst particles is maintained during use. The molar ratio of Group 6 to Group 8-10 non-noble metals ranges generally from 10:1-1:10 and preferably from 3:1-1:3, In the case of a core-shell structured particle, these ratios of course apply to the metals contained in the shell. If more than one Group 6 metal is contained in the bulk catalyst particles, the ratio of the different Group 6 metals is generally not critical. The same holds when more than one Group 8-10 non-noble metal is applied. In the case where molybdenum and tungsten are present as Group 6 metals, the molybdenum:tungsten ratio preferably lies in the range of 9:1-1:9. Preferably the Group 8-10 non-noble metal comprises nickel and/or cobalt. The Group 6 metal comprises a combination of molybdenum and tungsten. Preferably, combinations of nickel/molybdenum/tungsten and cobalt/molybdenum/tungsten and nickel/cobalt/molybdenum/tungsten are used. These types of precipitates appear to be sinter-resistant. Thus, the active surface area of the precipitate is maintained during use. The metals are preferably present as oxidic compounds of the corresponding metals, or if the catalyst composition has been sulfided, sulfidic compounds of the corresponding metals.

In some optional aspects, the bulk metal hydrotreating catalysts used herein have a surface area of at least 50 m²/g and more preferably of at least 100 m²/g. In such aspects, it is also desired that the pore size distribution of the bulk metal hydrotreating catalysts be approximately the same as the one of conventional hydrotreating catalysts. Bulk metal hydrotreating catalysts can have a pore volume of 0.05-5 ml/g, or of 0.1-4 ml/g, or of 0.1-3 ml/g, or of 0.1-2 tag determined by nitrogen adsorption. Preferably, pores smaller than 1 nm are not present. The bulk metal hydrotreating catalysts can have a median diameter of at least 50 nm, or at least 100 nm. The bulk metal hydrotreating catalysts can have a median diameter of not more than 5000 μm, or not more than 3000 μm. In an embodiment, the median particle diameter lies in the range of 0.1-50 μm and most preferably in the range of 0.5-50 μm.

In a multi-stage apparatus, an initial stage of the hydroprocessing apparatus can include one or more hydrotreating and/or hydrocracking catalysts. A separator can then be used in between the first and second stages of the apparatus to remove gas phase sulfur and nitrogen contaminants. One option for the separator is to simply perform a gas-liquid separation to remove contaminants. Another option is to use a separator such as a flash separator that can perform a separation at a higher temperature. Such a high temperature separator can be used, for example, to separate the feed into a portion boiling below a temperature cut point, such as about 350° F. (177° C.) or about 400° F. (204° C.), and a portion boiling above the temperature cut point. In this type of separation, the naphtha boiling range portion of the effluent from the initial stage can also be removed, thus reducing the volume of effluent that is processed in the second or other subsequent stages. Of course, any low boiling contaminants in the effluent from the first stage would also be separated into the portion boiling below the temperature cut point. If sufficient contaminant removal is performed in the initial stage, the second stage can be operated as a “sweet” or low contaminant stage.

Second Stage—Hydrocracking, Dewaxing and/or Hydrofinishing

In some aspects, a hydrocracking process can be optionally introduced into the second stage of the production process of base stocks, and hydrocracking catalyst can comprise any suitable or standard hydrocracking catalyst, for example, a zeolitic base selected from zeolite Beta, zeolite X, zeolite Y, faujasite, ultrastable Y (USY), dealuminized Y (Deal Y), Mordenite, ZSM-3, ZSM-4, ZSM-18, ZSM-20, ZSM-48, and combinations thereof, which zeolitic base can advantageously be loaded with one or more active metals (e.g., either (i) a Group 8-10 noble metal such as platinum and/or palladium or (ii) a Group 8-10 non-noble metal such nickel, cobalt, iron, and combinations thereof, and a Group 6 metal such as molybdenum and/or tungsten). In the present disclosure, “zeolitic materials” are defined to include materials having a recognized zeolite framework structure, such as framework structures recognized by the International Zeolite Association. Such zeolitic materials can correspond to silicoaluminates, silicoaluminophosphates, aluminophosphates, and/or other combinations of atoms that can be used to form a zeolitic framework structure. In addition to zeolitic materials, other types of crystalline acidic support materials may also be suitable. Optionally, a zeolitic material and/or other crystalline acidic material may be mixed or bound with other metal oxides such as alumina, titania, and/or silica.

A hydrocracking process can be carried out at temperatures of 200° C. to 450° C., hydrogen partial pressures of from 250 psi to 5000 psi (˜1.8 MPa to ˜34.6 MPa), liquid hourly space velocities of from 0.2 h⁻¹ to 10 h⁻¹, and hydrogen treat gas rates of from 35.6 m³/m³ to 1781 m³/m³ (˜200 SCF/B to ˜10,000 SCF/B), Typically, in most cases, the conditions can include temperatures in the range of 300° C. to 450° C., hydrogen partial pressures of from 500 psi to 2000 psi (˜3.5 MPa to ˜13.9 MPa), liquid hourly space velocities of from 0.3 h⁻¹ to 5 h⁻¹ and hydrogen treat gas rates of from 213 m³/m³ to 1068 m³/m³ (˜1200 SCF/B to ˜6000 SCF/B).

In yet another aspect, the second stage of the hydroprocessing apparatus may include more than one hydrocracking stage. If multiple hydrocracking stages are present, at least one hydrocracking stage can have effective hydrocracking conditions as described above, including a hydrogen partial pressure of at least about 1000 psi (˜6.9 MPa).

In various aspects, catalytic dewaxing can be included as part of a second and/or sweet processing stage. Preferably, the dewaxing catalysts are zeolites (and/or zeolitic crystals) that perform dewaxing primarily by isomerizing a hydrocarbon feedstock. More preferably, the catalysts are zeolites with a unidimensional pore structure. Suitable catalysts include 10-member ring pore zeolites, such as EU-1, ZSM-35 (or ferrierite), ZSM-11, ZSM-57, NU-87, SAPO-11, and ZSM-22. Preferred materials are EU-2, EU-11, ZBM-30, ZSM-48, or ZSM-23. ZSM-48 is most preferred. Note that a zeolite having the ZSM-23 structure with a silica to alumina ratio of from 20:1 to 40:1 can sometimes be referred to as SSZ-32. Other zeolitic crystals that are isostructural with the above materials include Theta-1, NU-10, EU-13, KZ-1, and NU-23. In some embodiments, the catalytic dewaxing is conducted in the presence of a dewaxing catalyst, which is selected from a group consisting of: 10-member ring pore zeolites, such as EU-1, ZSM-35 (or ferrierite), ZSM-11, ZSM-57, NU-87, SAPO-11, and ZSM-22, and combinations thereof.

In various embodiments, the dewaxing catalysts can further include a metal hydrogenation component. The metal hydrogenation component is typically a Group 6 and/or a Group 8-10 metal. Preferably, the metal hydrogenation component is a Group 8-10 noble metal. Preferably, the metal hydrogenation component is Pt, Pd, or a mixture thereof. In an alternative embodiment, the metal hydrogenation component can be a combination of a non-noble Group 8-10 metal with a Group 6 metal. Suitable combinations can include Ni, Co, or Fe with Mo or W, preferably Ni with Mo or W.

The metal hydrogenation component may be added to the dewaxing catalyst in any convenient manner. One technique for adding the metal hydrogenation component is by incipient wetness. For example, after combining a zeolite and a binder, the combined zeolite and binder can be extruded into catalyst particles. These catalyst particles can then be exposed to a solution containing a suitable metal precursor. Alternatively, metal can be added to the catalyst by ion exchange, where a metal precursor is added to a mixture of zeolite (or zeolite and binder) prior to extrusion.

The amount of metal in the dewaxing catalyst can be at least 0.1 wt % based on catalyst, or at least 0.15 wt %, or at least 0.2 wt %, or at least 0.25 wt %, or at least 0.3 wt %, or at least 0.5 wt % based on catalyst. The amount of metal in the catalyst can be 20 wt % or less based on catalyst, or 10 wt % or less, or 5 wt % or less, or 2.5 wt % or less, or 1 wt % or less. For aspects where the metal is Pt, Pd, another Group 8-10 noble metal, or a combination thereof, the amount of metal can be from 0.1 to 5 wt %, preferably from 0.1 to 2 wt %, or 0.25 to 1.8 wt %, or 0.4 to 1.5 wt %. For aspects where the metal is a combination of a non-noble Group 8-10 metal with a Group 6 metal, the combined amount of metal can be from 0.5 wt % to 20 wt %, or 1 wt % to 15 wt %, or 2.5 wt % to 10 wt %.

Preferably, a dewaxing catalyst can be a catalyst with a low ratio of silica, to alumina. For example, for ZSM-48, the ratio of silica to alumina in the zeolite can be less than 200:1, or less than 110:1, or less than 100:1, or less than 90:1, or less than 80:1. In particular, the ratio of silica to alumina can be from 30:1 to 200:1, or 60:1 to 110:1, or 70:1 to 100:1.

A dewaxing catalyst can also include a binder. In some embodiments, the dewaxing catalysts used in process according to the present disclosure are formulated using a low surface area binder, a low surface area binder represents a binder with a surface area of 100 m²/g or less, or 80 m²/g or less, or 70 m²/g or less, such as down to 40 m²/g or still lower.

Alternatively, the binder and the zeolite particle size can be selected to provide a catalyst with a desired ratio of micropore surface area to total surface area. In dewaxing catalysts used according to the present disclosure, the micropore surface area corresponds to surface area from the unidimensional pores of zeolites in the dewaxing catalyst. The total surface corresponds to the micropore surface area plus the external surface area. Any binder used in the catalyst will not contribute to the micropore surface area and will not significantly increase the total surface area of the catalyst. The external surface area represents the balance of the surface area of the total catalyst minus the micropore surface area. Both the binder and zeolite can contribute to the value of the external surface area. Preferably, the ratio of micropore surface area to total surface area for a dewaxing catalyst will be equal to or greater than 25%.

A zeolite (or other zeolitic material) can be combined with binder in any convenient manner. For example, a bound catalyst can be produced by starting with powders of both the zeolite and binder, combining and mulling the powders with added water to form a mixture, and then extruding the mixture to produce a bound catalyst of a desired size. Extrusion aids can also be used to modify the extrusion flow properties of the zeolite and binder mixture. Optionally, a binder can be composed of two or more metal oxides can also be used.

Process conditions in a catalytic dewaxing zone can include a temperature of from 200 to 450° C., preferably 270 to 400° C., a hydrogen partial pressure of from 1.8 to 34.6 MPa (˜250 to 5000 psi), preferably 4.8 to 20.8 MPa, a liquid hourly space velocity of from 0.2 to 10 hr′, preferably 0.5 to 3.0 hr⁻¹, and a hydrogen circulation rate of from 35.6 to 1781 m³/m³ (˜200 to ˜10,000 SCF/B), preferably 178 to 890.6 m³/m³ (˜1000 to ˜5000 scf/B). Additionally or alternately, the conditions can include temperatures in the range of 600° F. (˜343° C.) to 815° F. (˜435° C.), hydrogen partial pressures of from 500 psi to 3000 psi (˜3.5 MPa to ˜20.9 MPa), and hydrogen treat gas rates of from 213 m³/m³ to 1068 m³/m³ (˜1200 SCF/B to ˜6000 SCF/B).

In various aspects, a hydrofinishing process can also be provided. The hydrofinishing can occur prior to dewaxing and/or after dewaxing. The hydrofinishing can occur either before or after fractionation. If hydrofinishing occurs after fractionation, the hydrofinishing can be performed on one or more portions of the fractionated product, such as being performed on one or more lubricant base stock portions. Alternatively, the entire effluent from the last conversion or dewaxing process can be hydrofinished.

In some situations, a hydrofinishing process can refer to a single process performed using the same catalyst. Typically a hydrofinishing process will be performed in a separate reactor from dewaxing or hydrocracking processes for practical reasons, such as facilitating use of a lower temperature for the hydrofinishing process. However, an additional hydrofinishing reactor following a hydrocracking or dewaxing process but prior to fractionation could still be considered part of a second stage of an apparatus conceptually.

Hydrofinishing catalysts can include catalysts containing Group 6 metals, Group 8-10 metals, and mixtures thereof. In an embodiment, metals include at least one metal sulfide having a strong hydrogenation function. In another embodiment, the hydrofinishing catalyst can include a Group 8-10 noble metal, such as Pt, Pd, or a combination thereof. The mixture of metals may also be present as bulk metal catalysts wherein the amount of metal is 30 wt. % or greater based on catalyst. Suitable metal oxide supports include low acidic oxides such as silica, alumina, silica-aluminas or titania, preferably alumina. The hydrofinishing catalysts for aromatic saturation will comprise at least one metal having relatively strong hydrogenation function on a porous support. Typical support materials include amorphous or crystalline oxide materials such as alumina, silica, and silica-alumina. The support materials may also be modified, such as by halogenation, or in particular fluorination. The metal content of the catalyst is often as high as 20 weight percent for non-noble metals. In an embodiment, a hydrofinishing catalyst can include a crystalline material belonging to the M41S class or family of catalysts. The M41S family of catalysts are mesoporous materials having high silica content. Examples include MCM-41, MCM-48 and MCM-50. A member of this class is MCM-41. If separate catalysts are used for hydrofinishing, a hydrofinishing catalyst can be selected based on activity for improving product specifications.

Hydrofinishing conditions can include temperatures from 125° C. to 425° C., preferably 180° C. to 280° C., total pressures from 500 psi (˜3.4 MPa) to 3000 psi (˜20.7 MPa), preferably 1500 psi (˜10.3 MPa) to 2500 psi (˜17.2 MPa), and liquid hourly space velocity (LHSV) from 0.1 hr⁻¹ to 5 hr⁻¹, preferably 0.5 hr⁻¹ to 1.5 hr⁻¹.

Still another option can be to use a separator between the first and second stages of the hydroprocessing apparatus that can also perform at least a partial fractionation of the effluent from the first stage. In this type of aspect, the effluent from the first hydroprocessing stage can be separated into at least a portion boiling below the distillate (such as diesel) fuel range, a portion boiling in the distillate fuel range, and a portion boiling above the distillate fuel range. The distillate fuel range can be defined based on a conventional diesel boiling range, such as having a lower end cut point temperature of at least about 350° F. (177° C.) or at least about 400° F. (204° C.) to having an upper end cut point temperature of about 700° F. (371° C.) or less or 650° F. (343° C.) or less. Optionally, the distillate fuel range can be extended to include additional kerosene, such as by selecting a lower end cut point temperature of at least about 300° F. (149° C.).

A second fractionation or separation can be performed at one or more locations after a second or subsequent stage. In some aspects, a fractionation can be performed after hydrocracking in the second stage in the presence of the USY catalyst under sweet conditions. At least a lubricant base stock portion of the second stage hydrocracking effluent can then be sent to a dewaxing and/or hydrofinishing reactor for further processing. In some aspects, hydrocracking and dewaxing can be performed prior to a second fractionation. In some aspects, hydrocracking and dewaxing can be performed prior to a second fractionation. Optionally, hydrofinishing can be performed before a second fractionation, after a second fractionation, or both before and after. Finally, a base stock product with low aromatics and high paraffins is obtained. In a embodiment, the base stock product has an aromatics content of 2.0 wt % or less, a 3+ ring aromatics content of 0.1 wt % or less, or a combination thereof.

### Hydroprocessing Apparatuses

The present disclosure further provides an apparatus for producing an improved base stock comprising a separation unit and a hydroprocessing unit, wherein the separation unit comprises a membrane element having an average pore size from about 0.3 nanometer to about 10 nanometer, a retentate zone wherein a hydrocarbon feedstream with an initial boiling point of at least 600° F. and/or a final boiling point of no more than 1100° F. contacts a first side of the membrane element, and a permeate zone from which a permeate stream is obtained from a second side of the membrane element, wherein the permeate is further converted by the hydroprocessing unit into the base stock having a kinematic viscosity at 100° C. between about 2 to about 35 cSt, a viscosity index (VI) of at least 80, at least 90 wt % saturated molecules and less than 0.03 wt % sulfur. In some embodiments, the hydroprocessing unit comprises a hydrocracking reactor and a dewaxing reactor; the hydroprocessing unit further comprises a hydrotreating reactor, which comprises a hydrotreating feed inlet, a hydrotreating effluent outlet, and a fixed catalyst bed comprising a hydrotreating catalyst.

### EXAMPLES

The Examples below are provided to illustrate the improved product qualities and the benefits from specific embodiments of the present disclosure for producing an improved base stock product from a hydrocarbon feedstream via membrane separation and operating conditions of the present invention. These Examples only illustrate specific embodiments of the present invention and are not meant to limit the scope of the current invention.

### Test Methods

Wax Content is measured by differential scanning calorimetry (DSC) by reference with ASTM D5800. The wax content can be used to predict lubricant quality or performance with a higher wax content improving the quality of the feed stream for lubricant production.

Aromatics Content can be determined by any convenient method, such as by characterization using UV spectroscopy. ASTM D2008 provides a method for correlating data generated from UV/VIS spectroscopy with a weight of aromatics present in a sample.

### Example 1: Separations of a VGO Utilizing a 8 kD Nm) Ceramic Membrane Showing Permeate Wax Enhancement

A refinery VGO was utilized as the hydrocarbon feedstream to the membrane process. The VGO was permeated in a batch membrane process using an 8 kD cut off (or 2 nm nominal pore size), 47 mm diameter ceramic membrane coupon. The ceramic membranes has 2.5 mm thickness and is made up of TiO₂ support Layer and a TiO₂ selective layer. The support layer comprises about 80-90% of the membrane and the selective layer is about 10-20%. In the batch experimental process, 100-300 mL of hydrocarbon feed was added to a batch cell, the membrane was mounted at the bottom of the cell and ensured that it was sufficiently free of leaks or defects. The transmembrane pressure was held at 800 psig and the feed temperature was 100° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment three permeate samples were collected at 25, 50 and 75% yields. Table 2 shows the wax content enhancement for the three permeates. The membrane flux rate was observed to be in the range of 0.9-5.4 g/hr.

TABLE 1
Relative wax enhancement in 25, 50 and
75% permeate and decrease in retentate

| | | Permeates | | | |
|---|---|---|---|---|---|
| | Feed | P1 | P2 | P3 | Retentate |
| Description | VGO | (25% cut) | (50% cut) | (75% cut) | Ret |
| Wax wt. % | 11.6 | 13.0 | 15.2 | 14.1 | 8.2 |
| Relative Wax | 1.00 | 1.12 | 1.31 | 1.22 | 0.71 |

TABLE 2
Relative wax enhancement in 25, 50, and
75% permeate and decrease in retentate

| | | Permeates | | | |
|---|---|---|---|---|---|
| | Feed | P1 | P2 | P3 | Retentate |
| Description | VGO | (25% cut) | (50% cut) | (75% cut) | Ret |
| Wax wt. % | 12.0 | 13.0 | 15.2 | 14.1 | 8.2 |
| Relative Wax | 1.00 | 1.08 | 1.27 | 1.18 | 0.68 |

### Example 2: Separations of VGO Utilizing a 8 kD Nm) Ceramic Membrane Showing Improved Permeate VI

A refinery VGO was utilized as the hydrocarbon feed stream to the membrane process. The VGO was permeated in a batch membrane process using an 8 kD cut off (or 2 nm nominal pore size), 47 mm diameter ceramic membrane coupon. The ceramic membranes has 2.5 mm thickness and is made up of TiO₂ support layer and a TiO₂ selective layer. The support layer comprises about 80-90% of the membrane and the selective layer is about 10-20%. In the batch experimental process, 100-300 mL of hydrocarbon feed was added to a batch cell, the membrane was mounted at the bottom of the cell and ensured that it was sufficiently free of leaks or defects. The transmembrane pressure was held at 500-800 psig and the feed temperature was 25-60° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment, 3 permeate samples were collected at 25, and 50% yields. Table 3 shows the wax content enhancement for the three permeates, while Table 4 shows the improvement in the viscosity index of the permeate stream vs. the feed stream and shows the reduction in the viscosity of the permeates vs. the feed. FIG. 8 shows the reduction in the boiling point of the permeates (P1 and P2) compared to the feed stream. The data clearly shows the improvement in the properties of the VGO, such as the wax content and viscosity index, making it more suitable for the preparation of base stocks. The membrane flux rate was observed to be in the range of 0.7-7 g/hr.

TABLE 3
Relative wax enhancement in 25% and 50%
permeate and decrease in retentate

| | Feed | Permeates | | |
|---|---|---|---|---|
| | VGO | P1 | P2 | Retentate |
| Description | Run #63 | (25% cut) | (50% cut) | Ret |
| Wax wt. % | 12.0 | 12.8 | 12.5 | 8.5 |
| Relative Wax | 1.00 | 1.07 | 1.04 | 0.71 |

TABLE 4
Enhancement of the Viscosity Index (VI) in
25, 50% permeate and decrease in retentate

| | | Permeates | | |
|---|---|---|---|---|
| | Feed | P1 | P2 | Retentate |
| Description | VGO | (25% cut) | (50% cut) | Ret |
| Viscosity Index | 78.9 | 87.5 | 89.5 | 71.6 |
| Kinematic | 6.24 | 5.55 | 5.53 | 6.77 |
| Viscosity | | | | |
| (cST) @ 100° C. | | | | |

### Example 3: Separations of VGO Utilizing a 0.3 kD Asymmetric Polyimide Polymeric Membrane

A refinery VGO was utilized as the hydrocarbon feed stream to the membrane process. The VGO was permeated in a batch membrane process using a 0.3 kD cut-off, 47 mm diameter polymeric membrane coupon. The membrane is an asymmetric polyimide membrane with a thin (<500 nm selective layer) on a porous sub-structure as a supportive layer. In the batch experimental process, 100-300 mL of hydrocarbon feed was added to a batch cell, the membrane was mounted at the bottom of the cell and ensured that it was sufficiently free of leaks or defects. The transmembrane pressure was held at 700-800 psig and the feed temperature was 200-220° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment two permeate samples were collected at 6.2 and 12.4% yields. Table 5 shows the wax content enhancement for the three permeates, while Table 6 shows the improvement in the viscosity index of the permeate stream vs. the feed stream and shows the reduction in the viscosity of the permeates vs. the feed. The data shows the improvement in the properties of the VGO, such as the wax content and viscosity index, making it more suitable for the preparation of base stocks. The membrane flux rate is shown in FIG. 9.

TABLE 5
Relative wax enhancement in 6.2% and 12.4%
permeate and decrease in retentate

| | Feed | Permeates | | |
|---|---|---|---|---|
| | VGO | P1 | P2 | Retentate |
| Description | Run #65 | (6.2% cut) | (12.4% cut) | Ret |
| Wax wt. % | 12.0 | 12.8 | 12.8 | 12 |
| Relative Wax | 1.00 | 1.07 | 1.07 | 1.00 |

TABLE 6
Enhancement of the Viscosity Index (VI) in 6.2%,
12.4% permeate and decrease in retentate

| | Feed | Permeates | | |
|---|---|---|---|---|
| | VGO | P1 | P2 | Retentate |
| Description | Run #65 | (6.2% cut) | (12.4% cut) | Ret |
| Viscosity Index | 78.9 | 82.1 | 79.2 | 80.1 |
| Kinematic | 6.24 | 5.91 | 6.07 | 6.16 |
| Viscosity | | | | |
| (cST) @ 100° C. | | | | |

### Example 4: Separation of VGO Utilizing a 0.6 kD Thin Film Composite Polymeric Membrane

A refinery VGO feed was utilized as the hydrocarbon feed stream to the membrane process. The VGO was permeated in a batch membrane process using a 0.6 kD cut-off, 47 mm diameter polymeric membrane coupon. The membrane is a thin film composite membrane with a thin <500 nm selective layer of cross-linked silicone cast on a porous support layer fabricated of polyimide polymer. In the batch experimental process, 100-300 mL of hydrocarbon feed was added to a batch cell, the membrane was mounted at the bottom of the cell and ensured that it was sufficiently free of leaks or defects. The transmembrane pressure was held at 550-575 psig and the feed temperature was 90-95° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment, 3 permeate samples were collected at 5, 10 and 25% yields. Table 7 shows the wax content enhancement for the three permeates, while Table 8 shows the improvement in the viscosity index of the permeate stream vs. the feed stream and shows the reduction in the viscosity of the permeates vs. the feed. The data shows the improvement in the properties of the VGO, such as the wax content and viscosity index, making it more suitable for the preparation of base stocks.

TABLE 7
Relative wax enhancement in 5, 10 and 25%
and 50% permeate and decrease in retentate

| | Feed | | | | |
|---|---|---|---|---|---|
| | VGO | Permeates | | | |
| | Run | P1 | P2 | P3 | Retentate |
| Description | #68 | (5% cut) | (10% cut) | (25% cut) | Ret |
| Wax wt. % | 12.0 | 12.1 | 12.5 | 13.2 | 10.7 |
| Relative | 1.00 | 1.01 | 1.04 | 1.1 | 0.89 |
| Wax | | | | | |

TABLE 8
Enhancement of the Viscosity Index (VI) in 5, 10 and
25% and 50% permeate and decrease in retentate

| | Feed | | | | |
|---|---|---|---|---|---|
| | VGO | Permeates | | | |
| | Run | P1 | P2 | P3 | Retentate |
| Description | #68 | (5% cut) | (10% cut) | (25% cut) | Ret |
| Viscosity | 78.9 | 85.0 | 83.9 | 83.3 | 77.9 |
| Index | | | | | |
| Kinematic | 6.24 | 5.48 | 5.71 | 5.69 | 6.27 |
| Viscosity | | | | | |
| (cST) @ | | | | | |
| 100° C. | | | | | |

### Example 5: Separation of VGO Utilizing a 1.4 kD Thin Film Composite Membrane

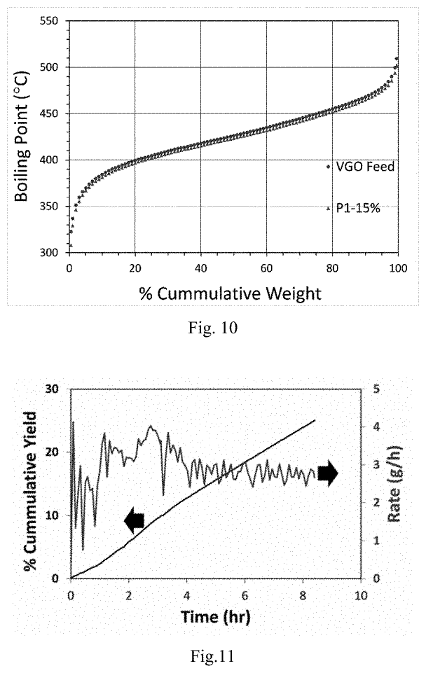

A refinery VGO feed was utilized as the hydrocarbon feed stream to the membrane process. The VGO was permeated in a batch membrane process using a 1.4 kD cut-off, 47 mm diameter polymeric membrane coupon. The membrane is a thin film composite membrane with a thin <500 nm selective layer of cross-linked silicone cast on a porous support layer fabricated of poly-ether imide polymer. In the batch experimental process, 100-300 mL of hydrocarbon feed was added to a batch cell, the membrane was mounted at the bottom of the cell and ensured that it was sufficiently free of leaks or defects. The transmembrane pressure was held at 200 psig and the feed temperature was 60° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment, 3 permeate samples were collected at 15% yields. Table 9 shows the wax content enhancement for the permeate, while Table 10 shows the improvement in the viscosity index of the permeate stream vs. the feed stream and shows the reduction in the viscosity of the permeates vs. the feed. FIG. 10 shows the reduction in the boiling point of the permeate (P1) compared to the feed stream using Simulated Distillation. The data shows the improvement in the properties of the VGO, such as the wax content and viscosity index, making it more suitable for the preparation of base stocks.

TABLE 9
Relative wax enhancement in 15% permeate
and decrease in retentate

| | Feed | | |
|---|---|---|---|
| | VGO | Permeate | Retentate |
| Description | Run #117 | P1 (15% cut) | Ret |
| Wax wt. % | 12.0 | 13.3 | 11.9 |
| Relative Wax | 1.00 | 1.11 | 0.99 |

TABLE 10
Enhancement of the Viscosity Index (VI)
in 15% permeate and decrease in retentate

| | Feed | | |
|---|---|---|---|
| | VGO | Permeates | Retentate |
| Description | Run #117 | P1 (15% cut) | Ret |
| Viscosity Index | 78.9 | 82.3 | 78 |
| Kinematic | 6.24 | 5.83 | 6.16 |
| Viscosity | | | |
| (cST) @ 100° C. | | | |

### Example 6: Separation of VGO Utilizing a 0.6 kD Thin Film Composite Polymeric Membrane Showing Changes in Permeate Molecular Composition

A refinery vacuum gas oil (VGO) feed was utilized as the hydrocarbon feed stream to the membrane process. The VGO was permeated in a batch membrane process using a 0.6 kD cut-off, 47 mm diameter polymeric membrane coupon. The membrane is a thin film composite membrane with a thin <500 nm selective layer of cross-linked silicone cast on a porous support layer fabricated of polyimide polymer. In the batch experimental process, 100-300 mL of hydrocarbon feed was added to a batch cell, the membrane was mounted at the bottom of the cell and ensured that it was sufficiently free of leaks or defects. The transmembrane pressure was held at 600 psig and the feed temperature was 90-115° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment, 3 permeate samples were collected at 5, 10 and 25% yields. Table 11 shows the breakdown of saturates and aromatics and sulfides in the feed, permeates and the retentate. It can be observed that the permeate streams are more enriched in the saturate vs. the feed along with lower amounts of 3, 4 ring aromatics and sulfides vs. the feed as desired for base stock production. The membrane flux rate is shown in FIG. 11.

TABLE 11
Breakdown of saturates, aromatics and sulfide content
in the feed vs. the permeates and the retentate

| Description | Feed | | | | |
|---|---|---|---|---|---|
| (wt %) | Run #125 | P1 (5%) | P2 (10%) | P3 (25%) | Retentate |
| Saturates | 56.2 | 57.4 | 58.4 | 55.6 | 54.7 |
| 1-ring | 14.4 | 14.0 | 14.1 | 13.5 | 12.8 |
| Aromatics | | | | | |
| 2-ring | 11.3 | 12.1 | 11.7 | 11.1 | 10.5 |
| Aromatics | | | | | |
| 3-ring | 9.1 | 9.0 | 8.5 | 8.2 | 7.7 |
| Aromatics | | | | | |
| 4-ring | 5.0 | 3.6 | 3.5 | 4.0 | 6.3 |
| Aromatics | | | | | |
| Sulfides | 4.0 | 3.8 | 3.7 | 7.6 | 6.0 |

### Example 7: Separations of Base Stock Utilizing a 0.3 kD Asymmetric Polyimide Polymeric Membrane

A base stock was utilized as the hydrocarbon feed stream to the membrane process. The feed was permeated in a batch membrane process using a 0.3 kD cut-off, 47 mm diameter asymmetric polyimide polymeric membrane coupon. The membrane is an asymmetric polyimide membrane with a thin (<500 nm selective layer) on a porous sub-structure as a supportive layer. In the batch experimental process, 100-300 mL of hydrocarbon feed was added to a batch cell, the membrane was mounted at the bottom of the cell and ensured that it was sufficiently free of leaks or defects. The transmembrane pressure was held at 600 psig and the feed temperature was 100-190° C. assisted with constant stirring at 400 rpm with a mechanical stirrer. Permeate samples then travelled through a heated permeate sample line and collected in vials. Select permeate samples and a retentate sample were extracted during the test along with flux rates and permeate yields measurement. In this experiment one permeate sample was collected at 5% yield. Table 12 shows the improvement in the viscosity index of the permeate stream vs. the feed stream and shows the reduction in the viscosity of the permeate vs. the retentate. Since the stage-cut or yield in this run was low, the VI of the retentate didn't decrease vs. the feed like in previous cases. The data shows the improvement in the properties of the base stock, such as viscosity index, can be improved by the use of membranes.

TABLE 12
Enhancement of the Viscosity Index (VI)
in 5% permeate and decrease in retentate

| | Feed | Permeates | |
|---|---|---|---|
| | Base Stock | P1 | Retentate |
| Description | Run #73 | (5% cut) | Ret |
| Viscosity Index | 115 | 120.1 | 115 |
| Kinematic | — | 4.68 | 5.27 |
| Viscosity | | | |
| (cST) @ 100° C. | | | |

### ADDITIONAL EMBODIMENTS

### Embodiment 1

A method for producing an improved base stock comprising a separation process, wherein the separation process comprises: conducting a hydrocarbon feedstream with an initial boiling point of at least 600° F. (˜316° C.) or a final boiling point of no more than 1100° F. (˜593° C.) to a membrane separation zone wherein the feedstream contacts a first side of at least one membrane element, wherein the membrane element has an average pore size from about 0.3 nanometer to about 10 nanometer; retrieving at least one retentate product stream from the first side of the membrane element; retrieving at least one permeate product stream from a second side of the membrane element; and processing at least a portion of the permeate product stream into the base stock having a kinematic viscosity at 100° C. between about 2 to about 35 cSt, a viscosity index (VI) of at least 80, at least 90 wt % saturated molecules and less than 0.03 wt % sulfur.

### Embodiment 2

The method of Embodiment 1, wherein the membrane is an organic membrane, an inorganic membrane, a supported liquid or facilitated transport membrane, a hybrid or mixed-matrix membrane, or a combinations thereof.

### Embodiment 3

The method of any of the previous embodiments, wherein the membrane is a polymeric membrane, a ceramic membrane, a porous glass membrane, or a combination thereof.

### Embodiment 4

The method of any of the previous embodiments, wherein the mixed-matrix membranes comprise inorganic particles as dispersed phase and a polymer matrix as continuous phase.

### Embodiment 5

The method of any of the previous embodiments, wherein the membrane has an average pore size from about 0.3 nanometer to about 2 nanometer.

### Embodiment 6

The method of any of the previous embodiments, wherein the membrane has a molecular weight cut-off of about 0.1 kD to about 200 kD.

### Embodiment 7

The method of any of the previous embodiments, wherein the membrane has a molecular weight cut-off of about 0.1 kD to about 8 kD.

### Embodiment 8

The method of any of the previous embodiments, wherein the membrane has a transmembrane pressure from about 200 psi to about 1500 psi.

### Embodiment 9

The method of any of the previous embodiments, wherein the separation process is conducted in a temperature of about 60° C. to about 400° C.

### Embodiment 10

The method of any of the previous embodiments, wherein the hydrocarbon feedstream is selected from the group consisting of deasphalted oil (DAO), vacuum gas oil (VGO), vacuum distillates, intermediate streams, and combinations thereof.

### Embodiment 11

The method of any of the previous embodiments, wherein the hydrocarbon feedstream has a T5 boiling point of at least 600° F. (˜316° C.) and a T95 boiling point of 1100° F. (˜593° C.) or less.

### Embodiment 12

The method of any of the previous embodiments, wherein the permeate product stream has an aromatics content of about 25 wt % to about 75 wt %.

### Embodiment 13

The method of any of the previous embodiments, wherein the hydrocarbon feedstream has an aromatics content of about 25 wt % to about 75 wt %.

### Embodiment 14

The method of any of the previous embodiments, wherein the base stock has a total aromatics content of 2.0 wt % or less, a 3+ ring aromatics content of 0.2 wt % or less, or a combination thereof.

### Embodiment 15

The method of any of the previous embodiments, wherein the conversion of step d) is through solvent process or hydroprocessing process.

### Embodiment 16

The method of any of the previous embodiments, wherein the hydroprocessing process comprises a first hydroprocessing stage and a second hydroprocessing stage, wherein the second hydroprocessing stage comprises a hydrocracking, a catalytic dewaxing, or a combination thereof.

### Embodiment 17

The method of any of the previous embodiments, wherein the catalytic dewaxing is conducted in the presence of a dewaxing catalyst, which is selected from a group consisting of: 10-member ring pore zeolites, such as EU-1, ZSM-35 (or ferrierite), ZSM-11, ZSM-57, NU-87, SAPO-11, ZSM-48 and ZSM-22, and combinations thereof.

### Embodiment 18

The method of any of the previous embodiments, wherein the first hydroprocessing stage comprises a hydrotreating process, a hydrocracking process, or a combination thereof.

### Embodiment 19

The method of any of the previous embodiments, wherein the second hydroprocessing stage further comprises a hydrofinishing process.

### Embodiment 20

An apparatus for producing an improved base stock comprising a separation unit and a hydroprocessing unit, wherein the separation unit comprises a membrane element having an average pore size from about 0.3 nanometer to about 10 nanometer, a retentate zone wherein a hydrocarbon feedstream with an initial boiling point of at least 600° F. and/or a final boiling point of no more than 1100° F. contacts a first side of the membrane element, and a permeate zone from which a permeate stream is obtained from a second side of the membrane element, wherein the permeate is further converted by the hydroprocessing unit into the base stock having a kinematic viscosity at 100° C. between about 2 to about 35 cSt, a viscosity index (VI) of at least 80, at least 90 wt % saturated molecules and less than 0.03 wt % sulfur.

### Embodiment 21

The apparatus of embodiment 20, wherein the membrane is selected from organic membranes, inorganic membranes, supported liquid or facilitated transport membranes, hybrid or mixed-matrix membranes, and combinations thereof.

### Embodiment 22

The apparatus of any of the previous embodiments, wherein the membrane is selected from a polymeric membrane, a ceramic membrane, a porous glass membrane, and combinations thereof.

### Embodiment 23

The apparatus of any of the previous embodiments, wherein the mixed-matrix membranes comprise inorganic particles as dispersed phase and a polymer matrix as continuous phase.

### Embodiment 24

The apparatus of any of the previous embodiments, wherein the membrane has an average pore size from about 0.3 nanometer to about 2 nanometer.

### Embodiment 25

The apparatus of any of the previous embodiments, wherein the membrane has a molecular weight cut-off of about 0.1 kD to about 200 kD.

### Embodiment 26

The apparatus of any of the previous embodiments, wherein the membrane has a molecular weight cut-off of about 0.1 kD to about 8 kD.

### Embodiment 27

The apparatus of any of the previous embodiments, wherein the membrane has a transmembrane pressure from about 200 psi to about 1500 psi.

### Embodiment 28

The apparatus of any of the previous embodiments, wherein the hydroprocessing unit comprises a hydrocracking reactor and a dewaxing reactor.

### Embodiment 29

The apparatus of any of the previous embodiments, wherein the hydroprocessing unit further comprises a hydrotreating reactor, which comprises a hydrotreating feed inlet, a hydrotreating effluent outlet, and a fixed catalyst bed comprising a hydrotreating catalyst.

### Embodiment 30

A separation method for producing an improved base stock comprising: conducting a base stock having a viscosity index (VI) of less than 120 to a membrane separation zone wherein the feedstream contacts a first side of at least one membrane element, wherein the membrane element has an average pore size from about 0.3 nanometer to about 10 nanometer; retrieving at least one retentate product stream from the first side of the membrane element; and retrieving at least one permeate product stream from a second side of the membrane element to produce the base stock having a viscosity index (VI) of at least 120, at least 90 wt % saturated molecules and less than 0.03 wt % sulfur.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for producing an improved base stock comprising:
a) conducting a hydrocarbon feedstream with an initial boiling point of at least 600° F. (˜316° C.) or a final boiling point of no more than 1100° F. (˜593° C.) to a membrane separation zone wherein the feedstream contacts a first side of at least one membrane element, wherein the membrane element has an average pore size from about 0.3 nanometer to about 10 nanometer;
b) retrieving at least one retentate product stream from the first side of the membrane element;
c) retrieving at least one permeate product stream from a second side of the membrane element; and
d) processing at least a portion of the permeate product stream into a base stock having a kinematic viscosity at 100° C. of about 2 to about 35 cSt, a viscosity index (VI) of at least 80, at least 90 wt % saturated molecules, and less than 0.03 wt % sulfur.

2. The method of claim 1, wherein the membrane is an organic membrane, an inorganic membrane, a supported liquid or facilitated transport membrane, a hybrid or mixed-matrix membrane, or a combination thereof.

3. The method of claim 2, wherein the mixed-matrix membranes comprise inorganic particles as dispersed phase and a polymer matrix as continuous phase.

4. The method of claim 1, wherein the membrane is a polymeric membrane, a ceramic membrane, a porous glass membrane, or a combinations thereof.

5. The method of claim 1, wherein the membrane has an average pore size from about 0.3 nanometer to about 2 nanometer.

6. The method of claim 1, wherein the membrane has a molecular weight cut-off of about 0.1 kD to about 200 kD.

7. The method of claim 1, wherein the membrane has a molecular weight cut-off of about 0.1 kD to about 8 kD.

8. The method of claim 1, wherein the membrane has a transmembrane pressure of about 200 psi to about 1500 psi.

9. The method of claim 1, wherein the membrane separation zone is at a temperature of about 60° C. to about 400° C.

10. The method of claim 1, wherein the hydrocarbon feedstream is selected from the group consisting of deasphalted oil (DAO), vacuum gas oil (VGO), vacuum distillates, intermediate streams, and combinations thereof.

11. The method of claim 1, wherein the hydrocarbon feedstream has a T5 boiling point of at least 600° F. (˜316° C.) and a T95 boiling point of 1100° F. (˜593° C.) or less.

12. The method of claim 1, wherein the permeate product stream has an aromatics content of about 25 wt % to about 75 wt %.

13. The method of claim 1, wherein the hydrocarbon feedstream has an aromatics content of about 25 wt % to about 75 wt %.

14. The method of claim 1, wherein the base stock has a total aromatics content of 2.0 wt % or less, a 3+ ring aromatics content of 0.2 wt % or less, or a combination thereof.

15. The method of claim 1, wherein step d) comprises a solvent process or a hydroprocessing process.

16. The method of claim 15, wherein the hydroprocessing process comprises a first hydroprocessing stage and a second hydroprocessing stage, wherein the second hydroprocessing stage comprises a hydrocracking, a catalytic dewaxing, or a combination thereof.

17. The method of claim 16, wherein the catalytic dewaxing is conducted in the presence of a dewaxing catalyst, which is selected from a group consisting of: 10-member ring pore zeolites, such as EU-1, ZSM-35 (or ferrierite), ZSM-11, ZSM-57, NU-87, SAPO-11, ZSM-48 and ZSM-22, and combinations thereof.

18. The method of claim 16, wherein the first hydroprocessing stage comprises a hydrotreating process, a hydrocracking process, or a combination thereof.

19. The method of claim 16, wherein the second hydroprocessing stage further comprises a hydrofinishing process.

20. An apparatus for producing an improved base stock comprising a separation unit and a hydroprocessing unit, wherein the separation unit comprises a membrane element having an average pore size from about 0.3 nanometer to about 10 nanometer, a retentate zone wherein a hydrocarbon feedstream with an initial boiling point of at least 600° F. and/or a final boiling point of no more than 1100° F. contacts a first side of the membrane element, and a permeate zone from which a permeate stream is obtained from a second side of the membrane element, wherein the permeate is further converted by the hydroprocessing unit into the base stock having a kinematic viscosity at 100° C. between about 2 to about 35 cSt, a viscosity index (VI) of at least 80, at least 90 wt % saturated molecules, and less than 0.03 wt % sulfur.

21. The apparatus of claim 20, wherein the membrane is selected from organic membranes, inorganic membranes, supported liquid or facilitated transport membranes, hybrid or mixed-matrix membranes, and combinations thereof.

22. The apparatus of claim 20, wherein the membrane is selected from a polymeric membrane, a ceramic membrane, a porous glass membrane, and combinations thereof.

23. The apparatus of claim 20, wherein the mixed-matrix membranes comprise inorganic particles as dispersed phase and a polymer matrix as continuous phase.

24. The apparatus of claim 20, wherein the membrane has an average pore size from about 0.3 nanometer to about 2 nanometer.

25. The apparatus of claim 20, wherein the membrane has a molecular weight cut-off of about 0.1 kD to about 200 kD.

26. The apparatus of claim 20, wherein the membrane has a molecular weight cut-off of about 0.1 kD to about 8 kD.

27. The apparatus of claim 20, wherein the membrane has a transmembrane pressure of about 200 psi to about 1500 psi.

28. The apparatus of claim 20, wherein the hydroprocessing unit comprises a hydrocracking reactor and a dewaxing reactor.

29. The apparatus of claim 28, wherein the hydroprocessing unit further comprises a hydrotreating reactor, which comprises a hydrotreating feed inlet, a hydrotreating effluent outlet, and a fixed catalyst bed comprising a hydrotreating catalyst.

30. A separation method for producing an improved base stock comprising:
a) conducting a base stock having a viscosity index (VI) of less than 120 to a membrane separation zone wherein the feedstream contacts a first side of at least one membrane element, wherein the membrane element has an average pore size from about 0.3 nanometer to about 10 nanometer;
b) retrieving at least one retentate product stream from the first side of the membrane element; and
c) retrieving at least one permeate product stream from a second side of the membrane element to produce the base stock having a viscosity index (VI) of at least 120, at least 90 wt % saturated molecules and less than 0.03 wt % sulfur.
